(19) United States
(12) Patent Application Publication
(10) Pub. No.: US 2026/0335890 A1
(43) Pub. Date: Oct. 29, 2026

(54) PASSIVE BALANCING FLUIDIC NETWORK

(71) Applicant: Miltenyi Biotec B.V. & Co KG, Bergisch Gladbach (DE)

(72) Inventor: John Harley, Goleta, CA (US)

(73) Assignee: Miltenyi Biotec B.V. & Co KG, Bergisch Gladbach (DE)

(21) Appl. No.: 19/442,401

(22) Filed: Jan. 7, 2026

Related U.S. Application Data
(60) Provisional application No. 63/742,917, filed on Jan. 8, 2025.

(51) Int. Cl. B01L 3/00

(52) U.S. Cl. CPC B01L 3/502746; B01L 3/50273; B01L 2200/0636; B01L 2400/086

(57) ABSTRACT

A fluidic network or channel system may passively stabilize the flow rates in the channels. The fluidic network may include a first microfluidic channel with a first fluidic resistance, at least one additional microfluidic channel with a second fluidic resistance R₂; wherein the at least one additional channel is disposed in parallel with the first microfluidic channel and flows are driven through both the first and the at least on additional channel by a pressure source. The fluidic network may further include a variable resistance valve disposed in the first microfluidic channel, wherein the variable resistance valve has a resistance Rᵥₐₗᵥₑ which increases with increasing velocity of flow through the valve, wherein the variable resistance valve adjusts the flow through the first channel based on the flow through the second channel, such that the flows through the network are passively stabilized by the variable resistance valve.

### CROSS REFERENCE TO RELATED APPLICATIONS

This US non-Provisional patent application claims priority to U.S. 63/742,917, filed Jan. 8, 2025. This prior application is incorporated by reference in its entirety.

### STATEMENT REGARDING FEDERALLY SPONSORED RESEARCH

Not applicable.

### STATEMENT REGARDING MICROFICHE APPENDIX

Not applicable.

### BACKGROUND

The present invention is directed to a system for the maintenance a flow through a microfluidic network having predefined properties.

With the advent of MEMS microprocessing techniques, it has become possible to form small, microfluidic channels which are interconnected into complex fluidic manifolds. Maintaining a well-defined flow through these channels which conforms to a desired characteristics can make control systems exceedingly complex and expensive.

Flows through these narrow channels may have fairly high Reynolds numbers, and thus it is important to control the velocity of the flow. For particle sorters, for example, sorters that separate rare cells from a patient sample, knowledge and tight control of the fluid velocity are critical factors in the success and efficiency of the sorting. Accordingly, substantial effort is put forth to maintain this flow within a tight range.

Active, feedback controlled servo motors can control the flow, but may be complex and costly. Such systems are particularly problematic for complex networks of microfabricated fluidic channels.

Accordingly, systems are desirable that are simple, cost effective and easy to control within a tight range.

### SUMMARY

This document describes a unique system that uses a variable flow valve design to achieve fluidic control in a microfluidic manifold using only passive, flow controlling devices. Central to this concept is a valve that operates conceptually like an electronic transistor, in that small changes to a base current can lead to large changes in a supply and power current.

The manifold may have a plurality of flow channels, wherein fluid flows with a Reynolds number of between about 10 and about 2000. A valve is disposed in one channel, whose flow resistance depends on the velocity of the flow. When the flow increases, the fluidic resistance also increases. By coupling a plurality of such channels together in a manifold, the flow in the channels may achieve a stable value. In this case, intermittent disruptions such as sudden, low flow (i.e. a clog) or high flow (i.e. a motor startup) may stabilize to the stable value. This embodiment may use only low cost, passive fluidic components.

Accordingly, disclosed herein is a network or channel system which may passively stabilize the flow rates in the channels. The fluidic network may include a first microfluidic channel with a first fluidic resistance, at least one additional microfluidic channel with a second fluidic resistance R₂; wherein the at least one additional channel is disposed in parallel with the first microfluidic channel and flows are driven through both the first and the at least on additional channel by a pressure source. The fluidic network may further include a variable resistance valve disposed in the first microfluidic channel, wherein the variable resistance valve has a resistance Rᵥₐₗᵥₑ which increases with increasing velocity of flow through the valve, wherein the variable resistance valve adjusts the flow through the first channel based on the flow through the second channel, such that the flows through the network are passively stabilized by the variable resistance valve.

### BRIEF DESCRIPTION OF THE DRAWINGS

Various exemplary details are described with reference to the following figures, wherein:

FIG. 1 is a conceptual drawing of a single fluid channel controlled with a single feedback control signal;

FIG. 2 is a conceptual drawing demonstrating the analogy to an electrical system;

FIG. 3 is a conceptual drawing of a two-channel manifold with a feedback control channel;

FIG. 4 is a conceptual drawing of a two-conductor system in a network, balanced by a transistor in the electrical analogy;

FIG. 5 is a conceptual drawing of a feedback system in a fluidic system using a valve whose resistance changes as a function of flow;

FIG. 6 is a conceptual drawing of the fluidic valve whose resistance changes as a function of flow;

FIG. 7 is a conceptual drawing of a fluidic device with variable resistance, in the forward direction (7a) and reverse direction (7b);

FIG. 8 is a model rendering demonstrating the transistor-like flow behavior through the fluidic transistor; FIG. 8a shows the vector field of the flow and FIG. 8b shows the resistance as a function of pressure;

FIG. 9 is a conceptual drawing of the passively balanced fluidic network, using valves whose fluid resistance changes as a function of flow;

FIG. 10 is a conceptual drawing illustrating the self-balancing behavior in the event of a clog in one of the channels of the passively-balanced fluidic manifold;

FIG. 11 is a conceptual drawing of an embodiment of the passively-controlled fluidic system using the fluidic transistor. Using a focusing structure; and

FIG. 12 is a conceptual illustration of an embodiment in more detail of the passively-controlled fluidic system using the fluidic transistor.

It should be understood that the drawings are not necessarily to scale, and that like numbers may refer to like features.

### DETAILED DESCRIPTION

Accordingly, described here is a fluidic system which may passively balance the flows in a network using valves whose resistance to transmission depend on the rate of flow within the channel. The mechanism along with several embodiments are described below with respect to the accompanying figures.

The fluidic system may include a network of microfabricated channels, although the techniques described below may be applied to macroscopic systems as well, by enlarging the dimensions proportionately.

In the embodiment described here, the fluidic network may include a first upstream channel, and a first downstream channel, wherein the “upstream” and “downstream” designation is made with respect to the valve, which is disposed between the upstream and the downstream channels.

A second upstream channel and a second downstream channel may also be included in the network, although it should be understood that these techniques may be applied to larger numbers of upstream and downstream channels. As before, the “upstream” and “downstream” designation is made with respect to a second valve, which is disposed between the second upstream and the downstream channels.

Finally, an exemplary embodiment is described, which makes use of the techniques disclosed herein to create a fluid network with flows in the legs of the network which are passively balanced. As used herein, the term “passively balanced” should be understood to mean that the flows in the legs are balanced by the geometry of the networks and the valves themselves, rather than by an actively managed flow controller.

The fluid flow channels described herein, may be microfabricated. In particular, these channels may be defined very precisely and with very small dimensions using integrated circuit microfabrication technologies such as lithography, etching and vacuum deposition.

The use of such techniques to form small structures on, for example, a silicon substrate, is known in the art as microelectromechanical systems (MEMS) techniques. Additional information as to manufacturing methods may be found in U.S. patent application Ser. No. 15/638,320, filed Jun. 29, 2017 and incorporated by reference in its entirety. The techniques may include forming a mask with the desired outline using photo resist, and etching the channels through such a mask to transfer the shapes into the silicon. An embodiment is described which uses such techniques, but it should be understood that this embodiment is exemplary only. The concepts may also be applied to larger, macroscopic systems by scaling dimensions.

The following discussion presents a plurality of exemplary embodiments of the novel fluid handling system. The following reference numbers are used in the accompanying figures to refer to the following:
10 and 10′ first upstream fluid channel and first upstream electrical conductor
11 and 11′ first downstream fluid channel and first downstream electrical conductor
12 and 12′ measuring device
14 and 14′ feedback signal
20 and 20′ second upstream fluid channel and first upstream electrical conductor
21 and 21′ second downstream fluid channel and second downstream electrical conductor
100 fluidic transistor
32 control base signal
112 straight region of transistor
114 curved region of transistor
80 clog

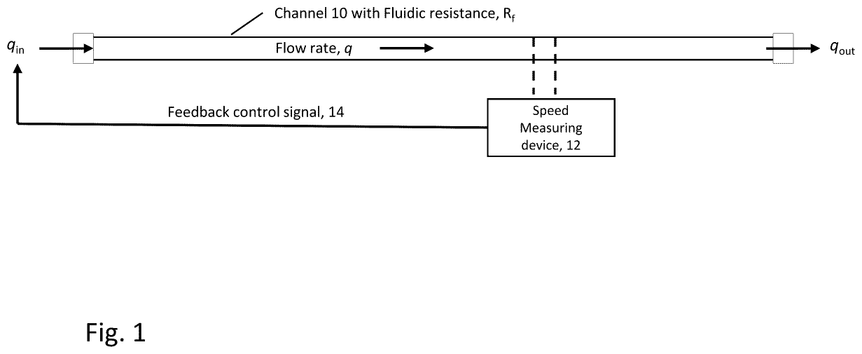

FIG. 1 is a conceptual drawing of a single fluid channel controlled with a single feedback control signal. As shown in FIG. 1, flow control in a single channel can be accomplished by a simple feedback circuit, using speed in a channel as the control signal.

In particular, FIG. 1 depicts a channel 10 which may have a characteristic fluid resistance R_{f}. If the channel is pressurized by, for example, a fluid pump, the channel 10 may allow a flow at a rate q which depends on the channel's fluidic resistance R_{f} and the pumping pressure, P. It is clear that from FIG. 1, that the input flow qᵢₙ equals the output flow, qₒᵤₜ. As is well known, the application of a pressure P to the fluid may cause a flow in the channel, which depends on the fluid resistance of the channel, according to qᵢₙ=qₒᵤₜ=P/R_{f}.

There may also be a fluid speed measuring device 12 which may be some type of anemometer which measures the rate of fluid flow. The sensor 12 may output a feedback control signal 14, which is representative of the flow rate q in the channel. The feedback control signal 14 may be routed to a controller that will raise or lower the flow rate q by raising or lowering the pump pressure P. In this way, the velocity of the flow through the channel may be controlled. Such techniques are commonly used to control flow rates in a channel.
(1) uidic systems,
(2) luidic systems,

As is known in the art of fluid mechanics, the flow of a fluid through a channel has many similarities to the behavior of current through a conductor. Thus, in the electrical system, voltage is analogous to pressure, and current is analogous to fluid flow. In this and the figures which follow, a single quote (′) refers to the electrical analogy of the fluid network. Accordingly, reference number 10 refers to a first fluidic channel, and reference number 10′ refers to a first electrical conductor.

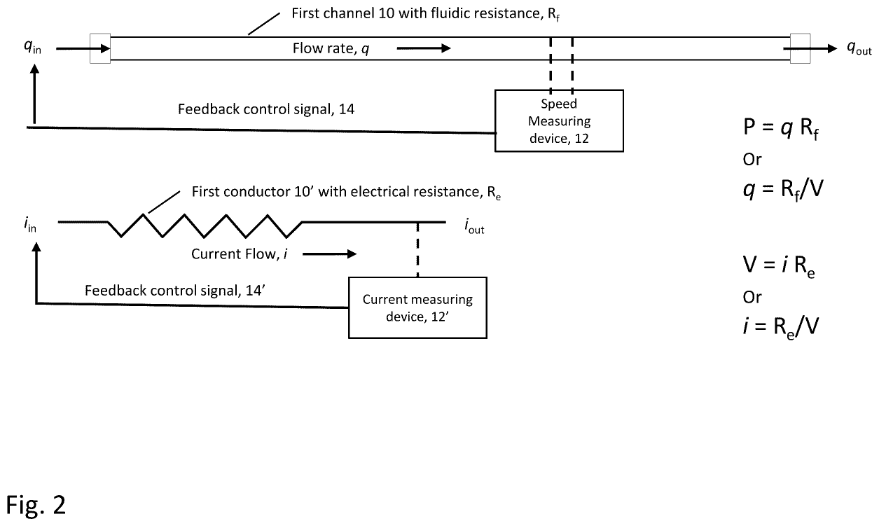

The electrical analog of the fluid system in FIG. 1, is shown in FIG. 2. As shown in FIG. 2, the channel 10 is replaced with a conductor 10′, which allows a current, i, to flow. If the conductor has an electrical resistance, Rₑ, the magnitude of this current behaves according to Ohms Law.

[symbol]

Accordingly, flow through a channel, and more particularly, flow through a network of channels, can be understood using concepts of electrical current transport. FIG. 2 is a conceptual drawing demonstrating the analogy to an electrical system.

As shown in FIG. 2, to control the flow in the channel 10 or conductor 10′, a sensor 12 may be used to measure the velocity, v, of the flow. The velocity, v, may be related to the flow q by the relation q=v A, where A is the cross sectional area of the fluid channel.

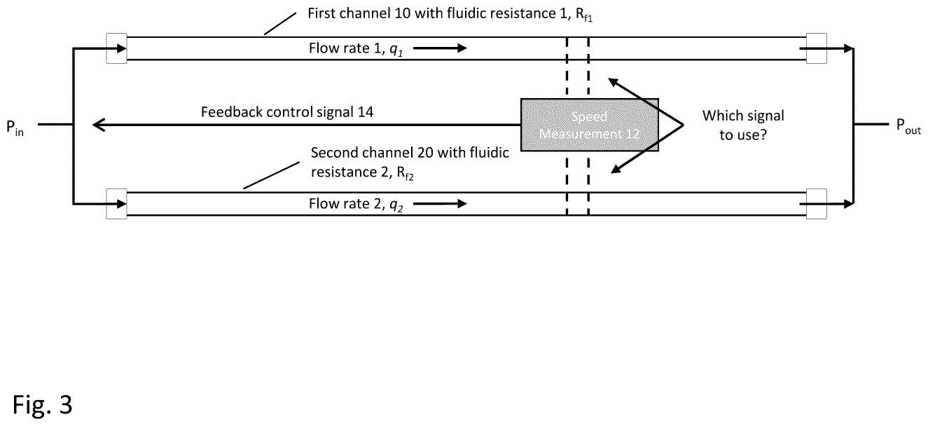

Despite the apparent simplicity of the single channel and single conductor systems shown in FIGS. 1 and 2, complications of this simple control system arise when two or more channels are coupled together and in fluid communication. The situation is illustrated in FIG. 3.

FIG. 3 is a conceptual drawing of a two-channel manifold with a feedback control channel. Comparing FIG. 3 to FIG. 2, there may be again a channel 10 which may have a characteristic fluid resistance R_{f1}. There may be a flow in the first channel q₁ resulting from the pressure applied.

However, as shown in FIG. 3, in addition to the first channel 10 there may be a second channel 20 which also has a fluid flowing in the channel q₂ as a result of the applied pressure P. Clearly, the flow in the first channel with resistance R_{f1} may not be the same as the flow q₂ in the second channel with resistance R_{f2}.

As before, there may be a measuring device 12 in the first channel 10 that may sense the flow q of the fluid in channel 10. But there may also be a second measuring device in the second channel to sense the flow q₂. So there are two possible control signals, q₁ and q₂, but only one adjustable control variable, which is the pressure P.

Accordingly, as shown in FIG. 3, the same type of control does not work in the case of multiple parallel channels. Because the input pressure is shared between channels, flow can only be controlled for all parallel channels together. If the fluidic resistance is exactly the same in each parallel channel, the flow rate and velocity will be the same in each and all is well. But if the fluidic resistance is not the same, and especially if it is transiently different, such as for example with a clog in the channel, the flow rate and velocity will be different. (Two parallel channels are shown, but this applies for n parallel channels in general).

More specifically, a sensor 12 may again produce a feedback signal 14. However as indicated in FIG. 3, this signal may be relative to the first fluid channel or the second fluid channel, or it may be some combination of both, for example, it may be an average value. The signal may be used to control the input pressure, but this pressure is shared by both channels 10 and 20. And thus there is an ambiguity in the flow through this fluid network, because although there may be multiple sensor signals, there is only one control parameter, which is input pressure. This scenario would clearly affect the control algorithm.

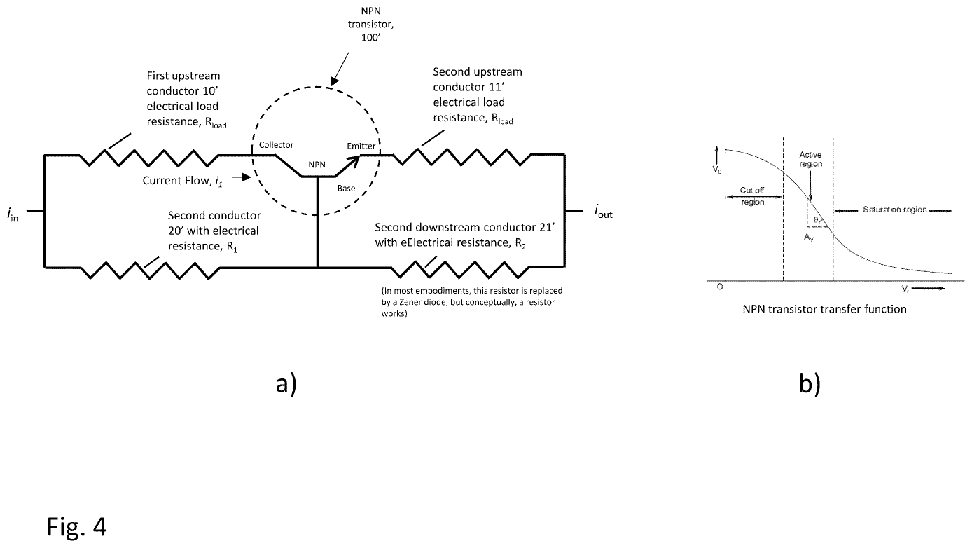

Once again, fluidic flow is analogous to current flow, and thus this same difficulty applies to an electrical manifold, a manifold with a plurality (at least two) of channels. This analogous system is depicted in FIG. 4.

FIG. 4 is a conceptual drawing of an analogous two-conductor system in the electrical analogy. Similarly to the fluidic system in FIG. 3, multiple feedback signals can be collected, but there is only one combined voltage that can be controlled.

As shown in FIG. 4, the network may have two branches, an upper branch and a lower branch. These branches may be connected in parallel to a voltage source. Each branch may each have two segments, an “upstream” segment and a “downstream” segment. Each of these segments may have a different electrical resistance. Between the two segments in the upper branch there may be a current controlling device 100′ which as shown may be a transistor. In FIG. 4,

[symbol] Accordingly, Rₑ₁ is the resistance of the first conductor 10′, and Rₑ₂ is the resistance of the second conductor 20′, and iₑᵢ is the current in the first conductor and iₑ₂ is the current in the second conductor. These quantities are related as demonstrated in Eqs. 1-4 above. As a consequence, if then

If the first (upper) leg of the network powers a load, and the resistance of this leg may be R_{load}. The lower leg also carries a current, whose value is determined by the resistance in its two segments R₁ and R₂. FIG. 4a shows the circuit, and FIG. 4b shows the transport characteristics of the electrical circuit of FIG. 4a.

In this electrical analogy, a device is used to alter the amount of current flowing to the load resistor R_{load}. In the embodiment shown in FIG. 4, the device is an NPN transistor. But as is well known, other types of transistors exist, and may also be used.

For this case, the transistor 100′ may be used to alter the electrical resistance the current network. In some embodiments, an NPN transistor may be used to modify the resistance to the operating characteristics of this manifold. The NPN transistor may have an emitter, a base and a collector, wired as shown in FIG. 4. Controlling the current applied to the base controls the current flowing in the emitter and collector, and thus controls the effective resistance of the network. If the base current is derived from the current flowing from a second leg of the network as shown, the characteristics of the current flow may be affected.

More particularly, if the base current is taken from the second branch as shown, and between the two segments making of the branch, the current flowing through the first leg, and thus the current to the load, may be controlled in a feedback loop using base current taken from the second branch.

Accordingly, as shown in FIGS. 4, in electronics, a current drive circuit may be used to allow independent current control. The circuit controls the flow of current, so that if the load resistance should change, the current flow remains constant. If the circuit contains a high current device with significant startup power requirements, for example, in an electrical motor, the resistance of the circuit may be much higher at startup than with the devices in their steady state conditions. In these scenarios, the electrical network using a transistor in an active feedback mode, may serve to stabilize the circuit, reducing overall power demands and avoiding over loading the devices with current or heat.

FIG. 4b shows NPN transistor transfer function. As shown in FIG. 4b, as the voltage applied to the base is zero, the voltage on the upper branch is at a maximum, which is to say, the switch is open and no current is flowing to the load. However when the voltage applied to the base begins to rise, current begins to flow. In the so-called linear or “active” region of the graph, the voltage (and so the current) is proportional to the base voltage. Beyond this active region, the transistor can no longer provide additional current, and the transistor enters the saturation region.

These transistor concepts are well known, especially in digital and analog electronics. In this illustration, the conductors are indicated by zigzag resistor elements, as is standard, compared to the straight lines that depict flow channels.

Accordingly, in the active region of the transistor, this system can be used in a feedback arrangement, to stabilize the flow of current through a network. It can especially be used to control the current applied to a load.

For completeness, it is observed that although FIG. 4 is depicted using an NPN transistor, PNP transistors may also be used to provide feedback and control to the circuit. PNP transistors are useful when the circuit operates as a normally closed switch (current is flowing) rather than a normally open switch (current is not flowing).

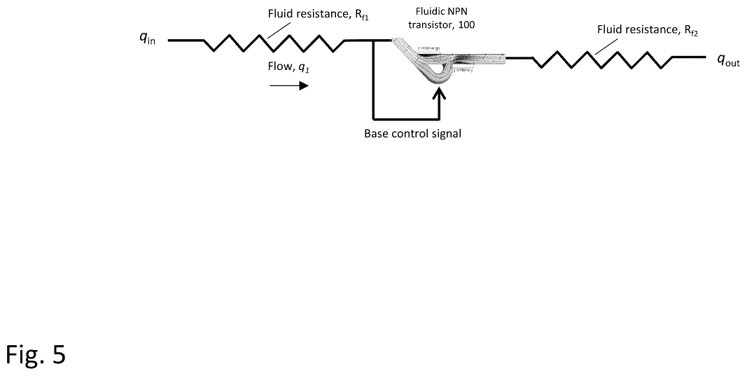

FIG. 5 is a conceptual drawing of the fluidic analog of the electrical system that was shown in FIG. 4. Element 100 is a variable flow controller, a device whose resistance to flow is a function of a control signal. In the electrical case, the control signal in the base current. In the fluidics case illustrated in FIG. 5, the control of the current flow and its variability, is an inherent feature of the specific details of the geometry of the variable flow controller 100. Although this device 100 may be referred to at times, as a “fluidic transistor,” it should be understood that this term refers to its behavior, which can be “transistor-like”. The behavior of this element 100 is described more fully below with respect to FIGS. 5-12.

The variable flow controller 100 is shown generically in FIG. 5 as having a “base control signal”. It should be understood that this behavior may not be in response to an actual signal as generated by a sensor or measuring device. That is, it should be understood that the fluid valves 100, 102 may not literally have a feedback signal in the sense that the electrical network does. The feedback signal is inherent in the construction and design of the fluidic valve, such that the resistance rises as the fluid velocity rises.

Instead, as mentioned above, this behavior may result from the design of the variable flow controller 100 itself. In the present case, the variable flow controller 100 is an element whose fluid resistance increases with higher flow velocity. The variable flow controller 100 could be, for example, a channel with flexible walls, where these flexible walls pinch the flow when a voltage is applied. To provide this deformation, the walls could be made including a PZT element applied to the flexible walls.

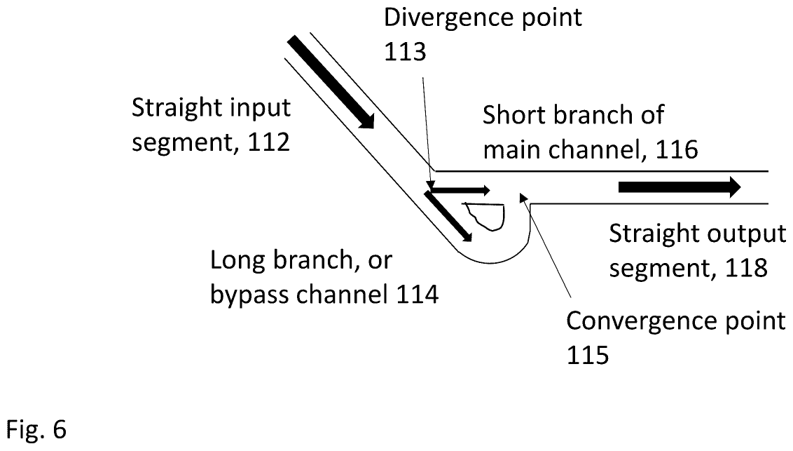

In other embodiments, the variable flow controller 100 may be a structure whose resistance changes as a function of fluid velocity. An example of such a structure is a Tesla valve, named after its inventor, Nikola Tesla. This structure is described below with respect to FIGS. 6-12.

Using a variable flow controller 100 in place of the electrical transistor, the flow in the channel may be controlled based on the details of the variable flow controller 100. For simplicity, only a single leg of the network is shown, having an upstream portion 1 and a downstream portion 2. The upstream portion may have an upstream resistance R_{f1} and the downstream portion may have a resistance R_{f2}.

Between the upstream segment 1 and the downstream segment 2 may be disposed the variable flow controller 100 or fluidic transistor. The resistance of the variable flow controller 100 largely determines the flow passing through the circuit. If a feedback signal can be generated, this signal could be used by variable flow controller 100 to stabilize or control the flow in the manifold.

FIG. 6 is a conceptual drawing of a fluid element which has variable resistance to flow. This device may have several primary features, but in particular, it has a shape which splits the fluid flow into two streams. When the streams are re-united, the passages are shaped such that one flow interferes significantly with the other.

In one embodiment of the above principles, the variable flow controller 100 may first have a long, relatively straight input channel that ends in a bifurcation point. This point separates the flow into a short main channel 116 and a longer bypass channel 114. The structure may also have a re-entry or union point, at which the flow from the two channels, the short main channel and the longer bypass channel, is recombined.

The shape of the longer bypass channel 114 is curved away from the short main channel 116, before it returns to the main channel 116 at the recombination point. Importantly, this flow at the recombination point from the longer bypass channel may impede, or interfere with, or pinch off, the flow coming from the short main channel. The greater the flow, the more significant the bypass channel impedance to the main channel flow, and thus the higher the fluid resistance. The output of the structure then proceeds 118 from this pinch off point.

By virtue of this shape, the Tesla valve may have one fluidic resistance with the fluid moving in one direction, say left to right in FIG. 6 and another fluid resistance when the fluid moves in the opposite direction. In this way, the Tesla valve may have a diode-like behavior, wherein the impedance has a forward and backwards value. Considering FIG. 6, it is clear that while the fluid flowing from left to right the main channel will experience interference from the bypass channel, when the fluid flows left to right, no such interference occurs when the fluid flows from right to left.

Accordingly, the fluidic resistance of this fluid valve 100 depends on the details of the flow field within the channels. In particular, this fluidic valve or fluidic transistor may have a substantially straight input portion 112 and a substantially straight output portion 118. Linking the input portion 112 to the output portion 118 are two fluidic paths, wherein the paths first diverge and then converge. These two fluidic paths diverge at an input point 113 and converge at an output point 115. An important aspect of this design is that at the convergence point 115, flow from one channel is inserted into the other channel, altering the pressure profile and interfering with the flow in that channel.

An example of a valve such as that depicted in FIG. 6, whose resistance depends on the flow is a Tesla Valve, invented and patented by Nicola Tesla in 1910. USP xxxxxx. The Tesla valve is an example of such a variable resistance valve, and may be suitable for the application disclosed here. In the remaining figures and discussion is directed at a microfabricated fluid channel network or manifold. The distinguishing feature of this system is that the flow through the system is controlled passively. By proper design of the valve 100 a system can be realized whose flow is constant despite disturbances such as a clog or other narrowing of the channel.

The invention had no moving parts. Like a diode, the fluidic resistance is higher in one direction than the other. The valve works by splitting the flow, and having a portion of it impinge back on the main flow. The impingement creates an effective narrowing of the flow path, resulting in higher resistance. In the opposite direction, the bypass channel is largely ignored, resulting in lower “pinching” of the fluid stream.

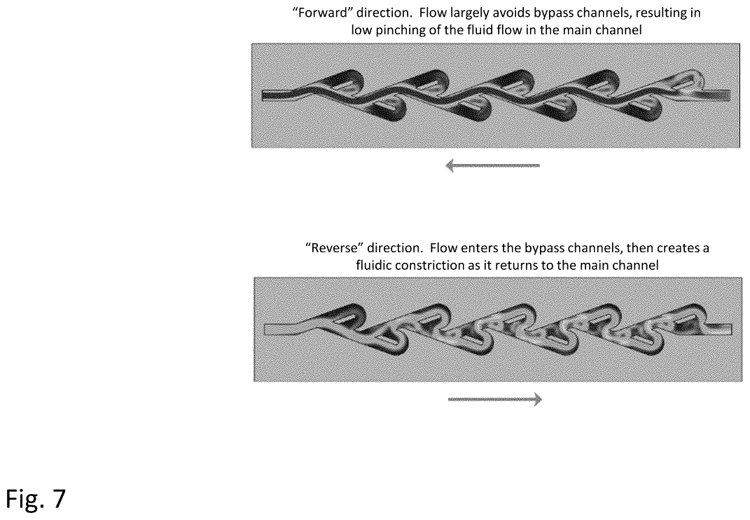

FIG. 7 is a conceptual drawing of set of a fluidic devices installed in a fluid channel. As shown in FIG. 7, because of the properties illustrated by the valve in FIGS. 5 and 6, the flow in one direction a) encounters far less resistance than flow in the opposite direction b). The term “fluidic transistor” is used herein to describe a Tesla-like variable flow valve, whose flow depends on the fluid velocity of the fluid flowing therein.

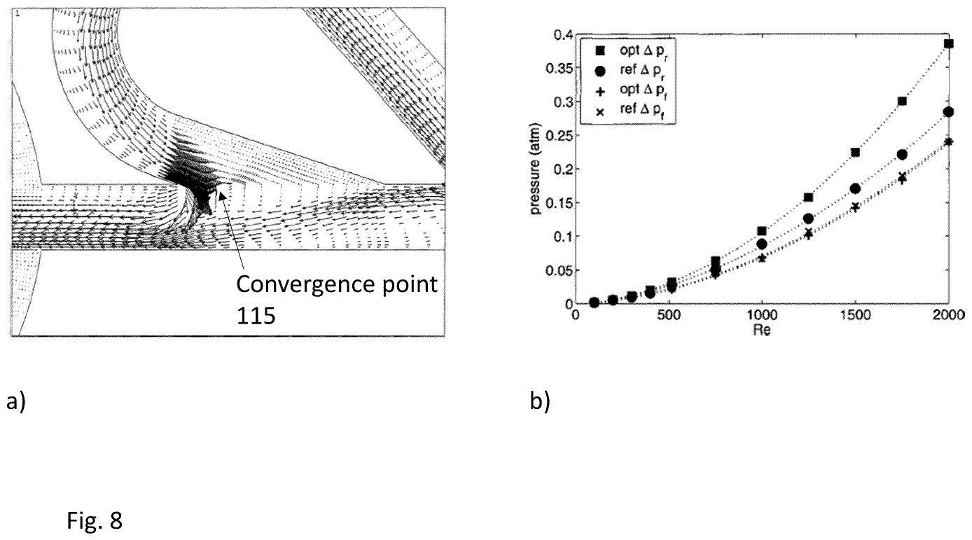

FIG. 8 is a model demonstrating the transistor-like flow behavior through the fluidic transistor. FIG. 8a is a vector plot of the velocity in the flow-loop return region. The divergence 113 and convergence point show the pinching effects of the bypass channel on the main channel.

FIG. 8b shows the difference between the forward and reverse pressure drop. The dotted curve in the plot of FIG. 8b is a second order curve of pressure drop versus Reynolds number. These data show that for a 2× increase in Reynolds number,

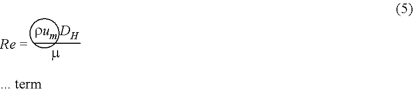

It is known that the diodic behavior of the variable resistance valve can be made to be non-linear. Flow restriction caused by Tesla valve is a function of momentum, not pressure. Reynolds number and flow rate both have a linear dependence on momentum

Pressure drop caused by Tesla valve:

P_{T}∝Re^{n(Re)} (6)
adratic equation of 2^{nd} power in Reynolds number, as was shown in FIG. 8b.

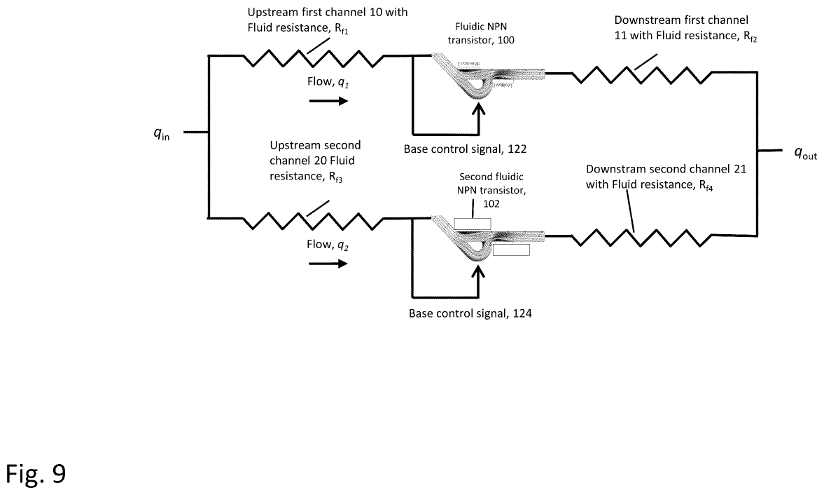

One embodiment of the network using the variable resistance valve is shown in FIG. 9. As shown in FIG. 9, the fluidic transistor may be used in the fluid manifold to balance the flows as described above. The Tesla valve or a similar structure used in reverse orientation creates a non-linear fluidic resistance increase as flow increases. The momentum of the fluid flow going into the fluidic transistor is the control signal that “turns off” the NPN fluid transistor. Because fluidic resistance increases with increasing flow rate, the flow path self-limits: more and more pressure is needed to drive fluid through the channel. The resistance increase is non-linear, making it relatively sensitive to flow rate changes.

FIG. 9 shows a first fluidic transistor 100 and a second fluidic transistor 102. The fluidic transistor 100 is controlled by a “base control signal 122” and the second fluidic resistor 102 is controlled by a “base control signal 124”. However, it should be understood that the base control signal shown here is not meant to suggest an actual physical connection. It only represents the fact that the fluidic transistor is self-referencing based on the flow entering the transistor element.

Accordingly, FIG. 9 shows the multi-channel network using the variable flow controller 100 and 102. As before, there is a first channel 10 and a second channel 20. Each of these has an upstream and a downstream component relative to the transistor 100 and 102. The first upstream channel 10 has a fluidic resistance R_{f1} and the first downstream channel 11 has another fluid resistance R_{f2}. The second upstream channel 20 has another fluidic resistance R_{f3} its downstream component may have another resistance R_{f4}.

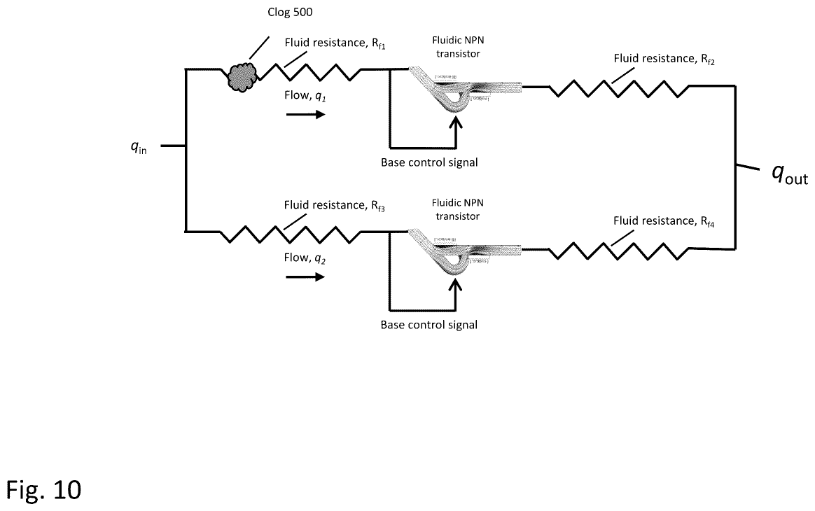

FIG. 10 is a conceptual drawing illustrating the passive self-balancing behavior in the fluidic transistor flow system. In the embodiment shown in FIG. 10, the flows in both the first and the second channels may interact. If the upper channel has higher resistance, less fluid will flow which will drop the resistance of the channel. Likewise, is the upper channel has lower resistance, more fluid will flow which again raises the resistance of the variable flow valves 100 and 102.

In other words, as shown in FIG. 10, in the parallel flow embodiment, the variable resistance valve or a similar structure may be used in “reverse” orientation, to create a non-linear fluidic resistance increase as flow increases.

More generally, this technique may also be used to balance flow networks that have one or more paths that are intentionally higher resistance due to design considerations. For example, if one flow path in a parallel network has to be longer than the others, these passive transistor elements will cause the flow in the other channels to decrease in order to compensate for the one channel that has a naturally higher fluidic resistance due to the longer flow path.

Most embodiments of these concepts will use relatively low velocity flows, well above creeping but well under turbulent. Reynolds numbers in the range Re>10 and Re<2000 are contemplated.

Because these concepts rely on the momentum of the fluid in the channels, different diodic or transistor-like behavior may be expected from denser fluids. More viscous fluids may also have different characteristics. A difference of on the order of 10% forward v backwards resistance may be useful. The different may be quadratic with respect to the Reynolds number as discussed above with respect to FIG. 8b.

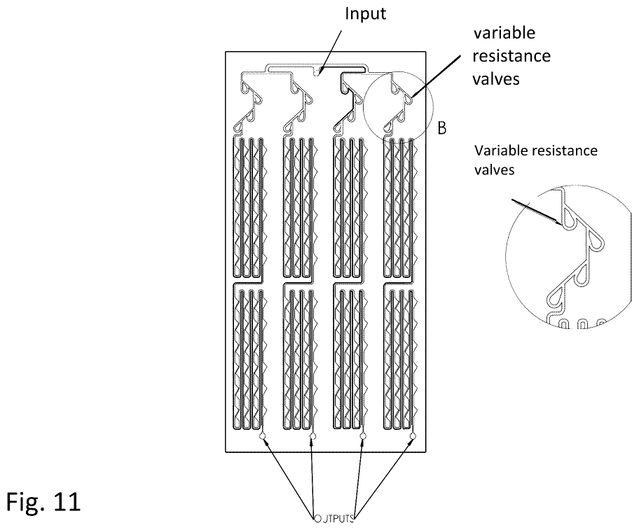

FIG. 11 is a conceptual drawing illustrating the self-balancing behavior in the event of a clog, 500, in one of the channels of the passively-balanced fluidic manifold. As shown in FIG. 11, again in the parallel flow embodiment, if fluidic resistance increases in one channel (i.e., due to clogging), flow rate will decrease in that channel driving increases in flow in other channels, driving increases resistance in other channels, then driving increases total drive pressure required, but balances the fluidic network.

In the event of a disruption in the steady flow, flows through the reverse variable resistance valve will decrease its resistance, and that will passively compensate for the change due to the clog, 500. More generally, if one channel in the parallel network begins to clog, flow in the others will increase. But this disproportionately increases the fluidic resistance in those channels, resulting in re-balancing of the fluidic network.

As is the case in any nonlinear system, depending on conditions, it is possible that unstable conditions could arise. This could result in a chaotic “hunting” behavior, where the channels will oscillate between different flow rates, rather than balancing. In this case, it may be necessary to add capacitive elements in the network to avoid this behavior. Or, depending on the time constant, this behavior might be a good thing to encourage, as it may help reduce clogging.

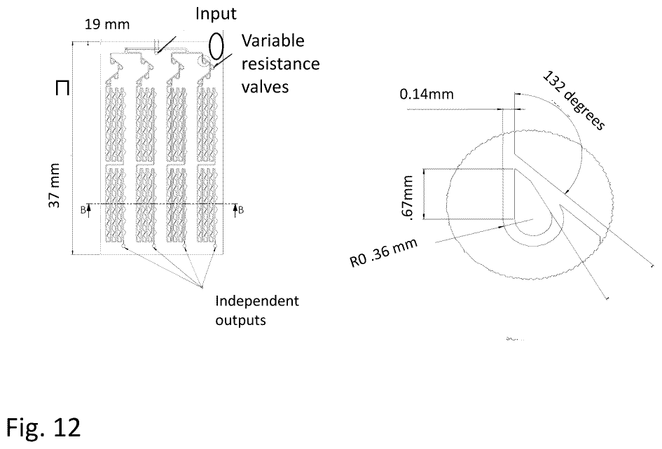

FIG. 12 shows greater detail of an embodiment that also includes an inertial focusing channel. Such channels are formed to make use of fluid forces that tend to urge particles in a fluid stream to concentrate into a particular streamline. An example is provided in the incorporated U.S. patent application Ser. No. 15/638,320, filed Jun. 29, 2017.

FIG. 12 provides some dimensions and operating parameters. The radius of curvature of the bypass channel may be 0.36 mm. The arc as illustrated may be about 132 degrees. The width of the input channel may be about 0.14 mm. The length of the main channel may be 0.67 mm. The overall dimensions of the device may be about 19×37 mm.

The concepts described above may be extended to using the fluidic transistor or variable resistance structures to create an intentionally unstable condition. This could be useful for something like attempting to free a clog in the system. Through the addition of a capacitive fluid element, such as a chamber that held a bubble of air, it would be possible to adjust the time constant of the instability. Small channels connecting the parallel fluid path would also create a capacitive balancing term that could be used to control the time constant. In such a system, the time constant may be on the order of a second or two, which means that it will be so much longer than the sorting time constant. That is, it will effectively appear to be uniform as far as the mechanism is concerned, but it may enable things like freeing clogs. Accordingly, some embodiments may include at least one capacitive element and at least one characteristic time constant. Therefore, some embodiments may exhibit an unbalanced, or chaotic behavior, which can be intentionally designed into such a system.

It should be understood that these details are exemplary only, and other embodiments, shapes and dimensions are contemplated.

Accordingly, a fluid network is disclosed. The fluidic network may include a first microfluidic channel with a first fluidic resistance, at least one additional microfluidic channel with a second fluidic resistance R₂, wherein the at least one additional channel is disposed in parallel with the first microfluidic channel and flows are driven through both the first and the at least on additional channel by a pressure source. In some embodiments, two valves may adjust simultaneously due to the change in flow in both valves at the same time. At the same time, a system with one fixed channel that doesn't have a valve and one that does is also contemplated. The fluidic network may include a variable resistance valve disposed in the first microfluidic channel, wherein the variable resistance valve has a resistance Rᵥₐₗᵥₑ which increases with increasing velocity of flow through the valve, and wherein the variable resistance valve adjusts the flow through the first channel based on the flow through the second channel, such that the flows through the network are passively stabilized by the variable resistance valve, the variable resistance valve may be a Tesla valve. Within the network, the channels may be on the order of 20-100 microns in width. The variable resistance valve comprises an input channel, a point of divergence where the flow splits into at least two streams, and a point of convergence where the at least two flows re-unite. Within the fluidic network, the variable resistance valve may have a partially circular channel, and a bypass channel, wherein flow through the bypass channel is hindered by flow in the partially circular channel. The fluidic network may further include at least two channels, and in each channel is disposed a variable resistance valve. The fluidic network may further include a fluid focusing element, shaped so as to urge particles in the stream into a streamline. The fluidic network may further include a pressure source that exerts pressure on the fluid in the channel, causing the fluid to flow in the channels and through the variable resistance valves. The characteristic time constant may be defined by the addition of a fluidic element, such that the fluidic behavior is chaotic or unstable. The fluidic element may function as a capacitive element in the microfluidic network.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. Accordingly, the exemplary implementations set forth above, are intended to be illustrative, not limiting.

What is claimed is:

1. A microfluidic network, comprising:
a first microfluidic channel with a first fluidic resistance;
at least one additional microfluidic channel with a second fluidic resistance R₂ wherein the at least one additional channel is disposed in parallel with the first microfluidic channel and flows are driven through both the first and the at least one additional channel by a pressure source;
a variable resistance valve disposed in the first microfluidic channel, wherein the variable resistance valve has a resistance Rᵥₐₗᵥₑ which increases with increasing velocity of flow through the valve,
wherein the variable resistance valve adjusts the flow through the first channel based on the flow through the second channel, such that the flows through the network are passively stabilized by the variable resistance valve.

2. The microfluidic network of claim 1, wherein the variable resistance valve is a Tesla valve.

3. The microfluidic network of claim 1, wherein the channels are on the order of 20-100 microns in width.

4. The microfluidic network of claim 1, wherein the variable resistance valve comprises an input channel, a point of divergence where the flow splits into at least two streams, and a point of convergence where the at least two flows re-unite.

5. The microfluidic network of claim 4, wherein the variable resistance valve has a partially circular channel, and a bypass channel, wherein flow through the bypass channel is hindered by flow in the partially circular channel.

6. The microfluidic network of claim 1, wherein the network includes at least two channels, and in each channel is disposed a variable resistance valve.

7. The microfluidic network of claim 1, further comprising a fluid focusing element, shaped so as to urge particles in the stream into a streamline.

8. The microfluidic network of claim 1, further comprising a pressure source that exerts pressure on the fluid in the channel, causing the fluid to flow in the channels and through the variable resistance valves.

9. The microfluidic network of claim 1, wherein a characteristic time constant is defined by the addition of a fluidic element, such that the fluidic behavior is chaotic or unstable.

10. The microfluidic network of claim 9, wherein the fluidic element functions as a capacitive element in the microfluidic network.
